(19) United States
(12) Patent Application Publication
(10) Pub. No.: US 2022/0256425 A1
(43) Pub. Date: Aug. 11, 2022

(54) METHOD AND APPARATUS FOR PROCESSING WHEN ACQUISITION OF ESSENTIAL SYSTEM INFORMATION FAILS

(71) Applicant: FUJITSU LIMITED, Kawasaki-shi (JP)

(72) Inventors: Meiyi JIA, Beijing (CN); Lei ZHANG, Beijing (CN); Xin WANG, Beijing (CN)

(73) Assignee: FUJITSU LIMITED, Kawasaki-shi (JP)

(21) Appl. No.: 17/731,351

(22) Filed: Apr. 28, 2022

Related U.S. Application Data
(63) Continuation of application No. PCT/CN2019/116410, filed on Nov. 7, 2019.

(51) Int. Cl. H04W 36/26; H04W 36/00; H04W 8/26

(52) U.S. Cl. CPC H04W 36/26; H04W 8/26; H04W 36/0007; H04W 36/00835

(57) ABSTRACT

A method and apparatus for processing when acquisition of essential system information fails. The method is applicable to a terminal equipment side and includes: in a process of evaluation of cell reselection by a terminal equipment, or in a case where a terminal equipment applies system information acquisition procedure, when the terminal equipment is unable to acquire the essential system information on least one cell on an unlicensed frequency, considering by the terminal equipment that all cells on the frequency are barred within a predefined first time, or, considering by the terminal equipment that the frequency is the lowest priority within a predefined first time.

### CROSS-REFERENCE TO RELATED APPLICATION

This application is a continuation application of International Application PCT/CN2019/116410 filed on Nov. 7, 2019 and designated the U.S., the entire contents of which are incorporated herein by reference.

### TECHNICAL FIELD

This disclosure relates to the field of communications.

### BACKGROUND

In a New Radio (NR) system, a terminal equipment applies a process of acquisition of system information to acquire AS (access) and NAS (non-access) information. This process is applicable to terminal equipments in an idle state, unconnected state and connected state.

The terminal equipment will apply the process of acquisition of system information when the terminal equipment performs cell selection (such as power on), or when the terminal equipment performs cell reselection, or when the terminal equipment turns back from out-of-coverage, or when the terminal equipment completes synchronization reconfiguration, or after the terminal equipment enters network from another RAT (radio access technology), or when the terminal equipment receives an indication on a change of system information, or when the terminal equipment receives a PWS (public warning system) notification, or once the terminal equipment has no stored system information block (SIB) of a valid version.

FIG. 1 is a schematic diagram of a process of acquisition of system information in NR. As shown in FIG. 1, a network device transmits a master information block (MIB) to a terminal equipment, and may also transmit a SIB1 (system information block typel); in addition, it may also be that the terminal equipment transmits a system information request to the network device, and then the network device transmits system information messages to the terminal equipment.

When the terminal equipment is in an idle state or inactive state or connected state and a timer T311 is running, when the terminal equipment is unable to obtain the MIB on a cell, the terminal equipment will take the cell as being barred and intraFreqReselection in the MIB will be taken as being set to allow to perform barring; when the terminal equipment obtains the MIB but cannot obtain the SIB1, the terminal equipment will take the cell as being barred; when intraFreqReselection in the MIB is set to be disallowed, the terminal equipment will consider that cell reselection of other cells on the same spectrum as the barred cell is disallowed; and when intraFreqReselection in MIB is set to be allowed, the terminal equipment will consider that cell reselection of other cells on the same spectrum as the barred cell is allowed.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

The problem of frequency resources is one of important topics in the discussion of communication technologies. In order to solve the problem of frequency resources, in addition to improving resource utilization, using more spectrum bands is tried in 3GPP, including using an unlicensed spectrum band, such as an NR-based access to unlicensed spectrum (NR-U) mechanism.

In the NR-U, as a network device and/or a terminal equipment need(s) to perform channel monitoring before communicating, that is, determine whether a channel is idle via a listen before talk (LBT) and/or a clear channel assessment (CCA) mechanism. When the channel is idle, the network device performs downlink transmission, such as transmitting an MIB and/or SIB1, and so on.

However, it was found by the inventors that in the NR-U, due to the LBT and/or the CCA, downlink transmission cannot be performed when the network device monitors that the channel is busy, hence, the network device may be unable to transmit the MIB and/or the SIB1, in which case the terminal equipment is unable to obtain the MIB/the SIB1. And also, all cells on the same frequency may be unable to transmit the MIB and/or the SIB1. According to a criterion of the NR, when the terminal equipment is unable to obtain the MIB on a cell, the cell is barred for 300 seconds (s); and when the terminal equipment obtains the MIB but is unable to obtain the SIB1, depending on intraFreqReselection in the MIB, the cell or the frequency where the cell is located is barred for 300 seconds. This means that the terminal equipment may always try to obtain the MIB and/or the SIB1 in cells on the same frequency; however, as the frequency is in a busy state, the terminal equipment will not be able to obtain the MIB and/or the SIB1 all the time. This may lead to increase of power consumption of the terminal equipment, and the terminal equipment will camp on a serving cell for an excessively long time.

In order to solve one or more of the above problems, embodiments of this disclosure provide a method and apparatus for processing when acquisition of essential system information fails.

According to a first aspect of the embodiments of this disclosure, there is provided an apparatus for processing when acquisition of essential system information fails, applicable to a terminal equipment side, the apparatus including: a first processing unit configured to, in a process of evaluation of cell reselection by a terminal equipment, or in a case where a terminal equipment applies system information acquisition procedure, when the terminal equipment is unable to acquire the essential system information on least one cell on an unlicensed frequency, consider that all cells on the frequency are barred within a predefined first time, or a second processing unit configured to, in a process of evaluation of cell reselection by a terminal equipment, or in a case where a terminal equipment applies system information acquisition procedure, when the terminal equipment is unable to acquire essential system information on least one cell on an unlicensed frequency, consider that the frequency is the lowest priority within a predefined first time.

According to a second aspect of the embodiments of this disclosure, there is provided an apparatus for configuring parameters for acquisition of essential system information, applicable to a network device side, the apparatus including: a configuring unit configured to configure a first number taken as the number of at least one cell for a terminal equipment, or configure a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

According to a third aspect of the embodiments of this disclosure, there is provided a terminal equipment, including the apparatus as described in the first aspect of the embodiments of this disclosure.

According to a fourth aspect of the embodiments of this disclosure, there is provided a network device, including the apparatus as described in the second aspect of the embodiments of this disclosure.

According to a fifth aspect of the embodiments of this disclosure, there is provided a communication system, including the network device t as described in the fourth aspect of the embodiments of this disclosure and/or the terminal equipment as described in the third aspect of the embodiments of this disclosure.

According to a sixth aspect of the embodiments of this disclosure, there is provided a method for processing when acquisition of essential system information fails, applicable to a terminal equipment side, the method including: in a process of evaluation of cell reselection by a terminal equipment, or in a case where a terminal equipment applies system information acquisition procedure, when the terminal equipment is unable to acquire the essential system information on least one cell on an unlicensed frequency, considering by the terminal equipment that all cells on the frequency are barred within a predefined first time, or, considering by the terminal equipment that the frequency is the lowest priority within a predefined first time.

According to a seventh aspect of the embodiments of this disclosure, there is provided a method for configuring parameters for acquisition of essential system information, applicable to a network device side, the method including: configuring a first number taken as the number of at least one cell for a terminal equipment, or configuring a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

According to an eighth aspect of the embodiments of this disclosure, there is provided a computer readable program, which, when executed in an apparatus for processing when acquisition of essential system information fails or a terminal equipment, will cause the apparatus for processing when acquisition of essential system information fails or the terminal equipment to carry out the method for processing when acquisition of essential system information fails as described in the sixth aspect of the embodiments of this disclosure.

According to a ninth aspect of the embodiments of this disclosure, there is provided a computer readable medium, including a computer readable program, which will cause an apparatus for processing when acquisition of essential system information fails or a terminal equipment to carry out the method for processing when acquisition of essential system information fails as described in the sixth aspect of the embodiments of this disclosure.

According to a tenth aspect of the embodiments of this disclosure, there is provided a computer readable program code, which, when executed in an apparatus for processing when acquisition of essential system information fails or a network device, will cause the apparatus for processing when acquisition of essential system information fails or the network device to carry out the method for processing when acquisition of essential system information fails as described in the seventh aspect of the embodiments of this disclosure.

According to an eleventh aspect of the embodiments of this disclosure, there is provided a computer readable medium, including a computer readable program, which will cause an apparatus for processing when acquisition of essential system information fails or a network device to carry out the method for processing when acquisition of essential system information fails as described in the seventh aspect of the embodiments of this disclosure.

An advantage of the embodiments of this disclosure exists in that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a process of acquisition of system information in NR;

FIG. 2 is a schematic diagram of a communication system of an embodiment of this disclosure;

FIG. 3 is a schematic diagram of the method for processing when acquisition of essential system information fails of Embodiment 1 of this disclosure;

FIG. 4 is a schematic diagram of the method for configuring parameters for acquisition of essential system information of Embodiment 2 of this disclosure;

FIG. 5 is a schematic diagram of the method for processing when acquisition of essential system information fails of Embodiment 3 of this disclosure;

FIG. 6 is a schematic diagram of the apparatus for processing when acquisition of essential system information fails of Embodiment 4 of this disclosure;

FIG. 7 is a schematic diagram of a first processing unit of Embodiment 4 of this disclosure;

FIG. 8 is another schematic diagram of the first processing unit of Embodiment 4 of this disclosure;

FIG. 9 is a further schematic diagram of the first processing unit of Embodiment 4 of this disclosure;

FIG. 10 is still another schematic diagram of the first processing unit of Embodiment 4 of this disclosure;

FIG. 11 is a schematic diagram of a second processing unit of Embodiment 4 of this disclosure;

FIG. 12 is another schematic diagram of the second processing unit of Embodiment 4 of this disclosure;

FIG. 13 is a further schematic diagram of the second processing unit of Embodiment 4 of this disclosure;

FIG. 14 is still another schematic diagram of the second processing unit of Embodiment 4 of this disclosure;

FIG. 15 is a schematic diagram of the apparatus for configuring parameters for acquisition of essential system information of Embodiment 5 of this disclosure;

FIG. 16 is a block diagram of a systematic structure of the terminal equipment of Embodiment 6 of this disclosure; and

FIG. 17 is a schematic diagram of a systematic structure of the network device of Embodiment 7 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (genescalen), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

In the embodiments of this disclosure, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios of the embodiments of this disclosure shall be described below by way of examples; however, this disclosure is not limited thereto.

FIG. 2 is a schematic diagram of a communication system of an embodiment of this disclosure, in which a case where a terminal equipment and a network device are taken as examples is schematically shown. As shown in FIG. 2, the communication system 100 may include a network device 101 and a terminal equipment 102. For the sake of simplicity, an example having only one terminal equipment is schematically given in FIG. 2. The network device 101 is, for example, a network device gNB of NR.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

Various implementations of the embodiments of this disclosure shall be described below with reference to the accompanying drawings. These embodiments are illustrative only, and are not intended to limit this disclosure.

### Embodiment 1

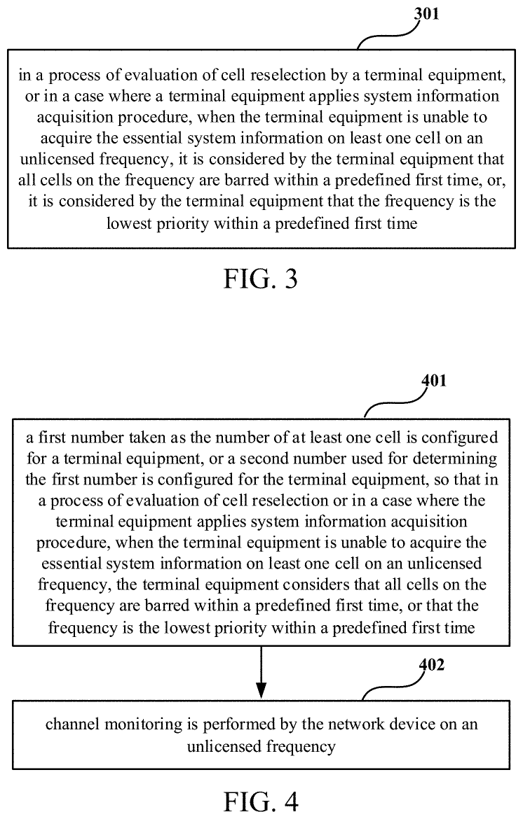

The embodiment of this disclosure provides a method for processing when acquisition of essential system information fails, applicable to a terminal equipment side. FIG. 3 is a schematic diagram of the method for processing when acquisition of essential system information fails of Embodiment 1 of this disclosure. As shown in FIG. 3, the method includes:

Step 301: in a process of evaluation of cell reselection by a terminal equipment, or in a case where a terminal equipment applies system information acquisition procedure, when the terminal equipment is unable to acquire the essential system information on least one cell on an unlicensed frequency, it is considered by the terminal equipment that all cells on the frequency are barred within a predefined first time, or, it is considered by the terminal equipment that the frequency is the lowest priority within a predefined first time.

In this way, the terminal equipment may be prevented from always making attempt to acquire essential system information on the same unlicensed frequency, thus enabling the terminal equipment to save power and find a suitable cell to camp on as soon as possible.

In this embodiment, for example, when the terminal equipment performs cell selection (such as power on) or cell reselection, when the terminal equipment turns back from out-of-coverage, or when the terminal equipment completes synchronization reconfiguration, or after the terminal equipment enters network from another RAT, or when the terminal equipment receives an indication on a change of system information, or when the terminal equipment receives a PWS notification, or once the terminal equipment has no stored SIB of a valid version, the terminal equipment will apply the process of acquisition of system information.

In this embodiment, the at least one cell on an unlicensed frequency may also be referred to as at least one unlicensed cell, and “unlicensed” refers to, for example, NR-U; in addition, “for NR-U” may refer to “when the cell is an NR-U cell”, or, “for NR-U” may also refer to “when the frequency is an NR-U frequency”.

In step 301, when the terminal equipment is unable to obtain the essential system information on least one cell on an unlicensed frequency, the terminal equipment performs appropriate processing, and checks the terminal equipment to determine the number of cells for obtaining the essential system information, i.e. the number of cells of the at least one cell; however, it is not limited in the embodiment of this disclosure.

In this embodiment, for example, the number of cells of the at least one cell is a first number, and the first number may be configured by a network device, or may be predefined, or may be determined by the terminal equipment.

For example, the first number configured by the network device is 2. When the terminal equipment checks whether the essential system information may be obtained in cells on an unlicensed frequency, it checks in 2 cells on the frequency. When the essential system information is unable to be obtained in the two cells on the frequency, the processing in step 301 is performed.

In this embodiment, for another example, the number of cells of the at least one cell is a first number, the first number is greater than or equal to a second number. The second number is an integer greater than or equal to 1, and may be configured by the network device, or may be predefined, or may be determined by the terminal equipment.

For example, the second number configured by the network device is 2. When the terminal equipment checks whether the essential system information may be obtained in cells on an unlicensed frequency, it checks in cells of a number greater than or equal to 2 on the frequency, such as checking in 3 cells on the frequency. When the essential system information is unable to be obtained in the three cells on the frequency, the processing in step 301 is performed.

In step 301, for example, according to whether the number of cells is one or more (i.e. at least two) and whether a processing method is that the terminal equipment considers that all cells on the frequency are barred within the predefined first time or the terminal equipment considers that the frequency is a frequency with a lowest priority within the predefined first time, different schemes may be combined.

For example, when the terminal equipment is unable to obtain essential system information on a cell on the unlicensed frequency, the terminal equipment considers that all cells on the frequency are barred within the predefined first time.

For another example, when the terminal equipment is unable to obtain essential system information on a cell on the unlicensed frequency, the terminal equipment considers that the frequency is a frequency with a lowest priority within the predefined first time.

For a further example, when the terminal equipment is unable to obtain essential system information on least two cells on the unlicensed frequency, the terminal equipment considers that all cells on the frequency are barred within the predefined first time.

For still another example, when the terminal equipment is unable to obtain essential system information on least two cells on the unlicensed frequency, the terminal equipment considers that the frequency is a frequency with a lowest priority within the predefined first time.

In this embodiment, the essential system information may include various system information necessary for transmission, such as at least one of the MIB and the SIB1.

In this embodiment, the first time is predefined, for example, the first time is less than or equal to a first threshold, the first threshold being, for example, 300 seconds.

For example, the first time is 300 seconds, or 100 seconds, or 50 seconds, or 10 seconds.

In this embodiment, for example, that the cell is barred may indicate that a cell state is “barred” or a cell state is taken as being “barred”. A behavior of the cell being barred is, for example, that the cell is not a candidate for cell selection or reselection, that is, the cell is excluded from candidates for selection or reselection.

In this embodiment, for the MIB and the SIB1 that is unable to be obtained as the essential system information, identical or different schemes may be adopted, that is, for the MIB and the SIB1 as the essential system information, the numbers of cells of the at least one cell may be identical or different, and/or the terminal equipment may adopt identical or different processing methods in methods where all cells on the frequency are barred and the frequency is a frequency with a lowest priority.

For example, when the terminal equipment is unable to acquire the MIB in N cells on an unlicensed frequency, the terminal equipment considers that all cells on the frequency are barred within the predefined first time; and/or, when the terminal equipment is unable to acquire the SIB1 in N cells on an unlicensed frequency, the terminal equipment considers that all cells on the frequency are barred within the predefined first time, N being an integer greater than or equal to 1.

For example, when the terminal equipment is unable to acquire the MIB in N cells on an unlicensed frequency, the terminal equipment considers that all cells on the frequency are barred within the predefined first time; and/or, when the terminal equipment is unable to acquire the SIB1 in M cells on an unlicensed frequency, the terminal equipment considers that all cells on the frequency are barred within the predefined first time.

For example, when the terminal equipment is unable to acquire the MIB in N cells on an unlicensed frequency, the terminal equipment considers that all cells on the frequency are barred within the predefined first time; and/or, when the terminal equipment is unable to acquire the SIB1 in N cells on an unlicensed frequency, the terminal equipment considers that the frequency is a frequency with a lowest priority, N being an integer greater than or equal to 1.

For example, when the terminal equipment is unable to acquire the MIB in N cells on an unlicensed frequency, the terminal equipment considers that all cells on the frequency are barred within the predefined first time; and/or, when the terminal equipment is unable to acquire the SIB1 in M cells on an unlicensed frequency, the terminal equipment considers that the frequency is a frequency with a lowest priority within the predefined first time, N and M being different integers.

For example, when the terminal equipment is unable to acquire the MIB in N cells on an unlicensed frequency, the terminal equipment considers that the frequency is a frequency with a lowest priority within the predefined first time; and/or, when the terminal equipment is unable to acquire the SIB1 in N cells on an unlicensed frequency, the terminal equipment considers that all cells on the frequency are barred within the predefined first time, N being an integer greater than or equal to 1.

For example, when the terminal equipment is unable to acquire the MIB in N cells on an unlicensed frequency, the terminal equipment considers that the frequency is a frequency with a lowest priority within the predefined first time; and/or, when the terminal equipment is unable to acquire the SIB1 in M cells on an unlicensed frequency, the terminal equipment considers that all cells on the frequency are barred within the predefined first time.

For example, when the terminal equipment is unable to acquire the MIB in N cells on an unlicensed frequency, the terminal equipment considers that the frequency is a frequency with a lowest priority within the predefined first time; and/or, when the terminal equipment is unable to acquire the SIB1 in N cells on an unlicensed frequency, the terminal equipment considers that the frequency is a frequency with a lowest priority within the predefined first time, N being an integer greater than or equal to 1.

For example, when the terminal equipment is unable to acquire the MIB in N cells on an unlicensed frequency, the terminal equipment considers that the frequency is a frequency with a lowest priority within the predefined first time; and/or, when the terminal equipment is unable to acquire the SIB1 in M cells on an unlicensed frequency, the terminal equipment considers that the frequency is a frequency with a lowest priority within the predefined first time, N and M being different integers.

Various possible cases shall be illustrated below.

Example 1: when the terminal equipment is unable to acquire at least one of the MIB and the SIB1 on least one cell on an unlicensed frequency, the terminal equipment considers that other cells on the same frequency as the at least one cell are not candidates for cell selection or reselection within the first time.

For a case where the number of cells of the at least one cell is 1, for example, for NR-U, when the terminal equipment has found that at least one of the MIB and the SIB1 is unable to be acquired, the terminal equipment may or will consider that other cells on the same frequency as the one cell are not candidates for cell selection or reselection within at most 300 seconds.

For a case where the number of cells of the at least one cell is multiple, such as at least 2, for example, for NR-U, when the terminal equipment has found that at least one of the MIB and the SIB1 is unable to be acquired on least two cells on a frequency, the terminal equipment may or will consider that other cells on the same frequency as the at least two cells are not candidates for cell selection or reselection within at most 300 seconds.

Example 2: when cell status “barred” is indicated or to be treated as when the cell status is “barred”, and when the cell is to be treated as when the cell status “barred” due to being unable to acquire the MIB and the cell is an NR-U cell, the terminal equipment excludes the cell and/or other cells on the same frequency from the candidates of cell selection or cell reselection within the first time, and/or, when cell status “barred” is indicated or to be treated as when the cell status is “barred”, when the terminal equipment acquires the MIB and when the cell is to be treated as when the cell status “barred” due to being unable to acquire the SIB1 and the cell is an NR-U cell, the terminal equipment excludes the cell and/or other cells on the same frequency from the candidates of cell selection or cell reselection within the first time. For example, when it is indicated that a state of a cell is “barred” or the state of a cell is treated as “barred”, (1) when the state of the cell is treated as “barred” due to that the cell is unable to acquire the MIB and the cell is an NR-U cell, the terminal equipment may or will exclude the cell as a candidate for cell selection or reselection for at most 300 seconds, and/or may or will exclude other cells on the same frequency as candidates for cell selection or reselection for at most 300 seconds; and (2) otherwise, i.e. the MIB is acquired and when the state of the cell is treated as “barred” due to that the cell is unable to acquire the SIB1 and the cell is an NR-U cell, the terminal equipment may or will exclude the cell as a candidate for cell selection or reselection for at most 300 seconds, and/or the terminal equipment may or will exclude other cells on the same frequency as candidates for cell selection or reselection for at most 300 seconds. The above processing (1) and (2) may be executed separately, or may be executed together.

Example 3: when cell status “barred” is indicated or to be treated as when the cell status is “barred”, and when the at least two cells on a frequency are to be treated as when the cell status “barred” due to being unable to acquire the MIB and the at least two cells are NR-U cells, the terminal equipment excludes other cells on the same frequency as the at least two cells from the candidates of cell selection or cell reselection within the first time, and/or,

when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, the terminal equipment excludes other cells on the same frequency as the at least two cells from the candidates of cell selection or cell reselection within the first time.

For example, when it is indicated that a state of a cell is “barred” or the state of a cell is treated as “barred”, (1) when the states of at least two cells on a frequency are treated as “barred” due to that the cells are unable to acquire the MIB and the at least two cells are NR-U cells, the terminal equipment may or will exclude other cells on the same frequency as candidates for cell selection or reselection for at most 300 seconds; and (2) otherwise, i.e. the MIB is acquired and when the states of at least two cells on a frequency are treated as “barred” due to that the cells are unable to acquire the SIB1 and the at least two cells are NR-U cells, the terminal equipment may or will exclude other cells on the same frequency as the cells as candidates for cell selection or reselection for at most 300 seconds. The above processing (1) and (2) may be executed separately, or may be executed together.

Example 4: when the terminal equipment is in an idle state, or in an inactive state, or in a connected state while a timer T311 is running, when the terminal equipment is unable to acquire the MIB on least one cell on an unlicensed frequency, the terminal equipment takes the at least one cell as barred and take intraFreqReselection in the MIB as being set to not allow to perform barring; and/or, when the terminal equipment is in an idle state or in an inactive state or in a connected state while a timer T311 is running, when the terminal equipment acquires the MIB and is unable to acquire the SD31 on least one cell on an unlicensed frequency, the terminal equipment takes the at least one cell as barred and take intraFreqReselection in the MIB as being set to not allow to perform barring.

For a case where the number of cells on the at least one cell is 1, for example, for NR-U, when the terminal equipment is in an idle state or an inactive state or a connected state and a timer T311 runs, (1) when the terminal equipment is unable to acquire the MIB on a cell, the terminal equipment may or will take the cell as barred and take intraFreqReselection in the MIB as being set to not allow to perform barring; and (2) when the terminal equipment acquires the MIB on a cell but is unable to acquire the SIB1, the terminal equipment may or will consider the cell as being barred; and the terminal equipment may or will take the cell as barred and take intraFreqReselection in the MIB as being set to not allow to perform barring, regardless of an actual value of intraFreqReselection in the MIB. The above processing (1) and (2) may be executed separately, or may be executed together.

For a case where the number of cells on the at least one cell is multiple, i.e. at least 2, for example, for NR-U, when the terminal equipment is in an idle state or an inactive state or a connected state and a timer T311 runs, (1) when the terminal equipment is unable to acquire the MIB on least two cells, the terminal equipment may or will take the at least two cells as barred and take intraFreqReselection in the MIB as being set to not allow to perform barring; and (2) when the MIB is acquired but the SIB1 is unable to be acquired on least two cells on a frequency, the terminal equipment may or will take the at least two cells as barred and take intraFreqReselection in the MIB as being set to not allow to perform barring, regardless of an actual value of intraFreqReselection in the MIB. The above processing (1) and (2) may be executed separately, or may be executed together.

Example 5: when the terminal equipment is unable to acquire at least one of the MIB and the SIB1 on least one cell on an unlicensed frequency, the terminal equipment considers the frequency of the at least one cell to be the lowest priority within the first time.

For a case where the number of cells on the at least one cell is 1, for example, for NR-U, when the terminal equipment has found that at least one of the MIB and the SIB1 is unable to be acquired on a cell, the terminal equipment may or will a frequency of the cell to be the lowest priority within at most 300 seconds.

For a case where the number of cells on the at least one cell is multiple, i.e. at least 2, for example, for NR-U, when the terminal equipment has found that at least one of the MIB and the SIB1 is unable to be obtained on least two cells, the terminal equipment may or will that a priority of the frequency of the cells is lowest within at most 300 seconds.

Example 6: when cell status “barred” is indicated or to be treated as when the cell status is “barred”, and when the cell is to be treated as when the cell status “barred” due to being unable to acquire the MIB and the cell is an NR-U cell, the terminal equipment excludes the cell from the candidates of cell selection or cell reselection within the first time, or considers a frequency of the cell to be the lowest priority within the first time; and/or, when cell status “barred” is indicated or to be treated as when the cell status is “barred”, and when the terminal equipment acquires the MIB and the cell is to be treated as when the cell status “barred” due to being unable to acquire the SIB1 and the cell is an NR-U cell, the terminal equipment excludes the cell from the candidates of cell selection or cell reselection within the first time, or considers a frequency of the cell to be the lowest priority within the first time.

For example, when it is indicated that a state of a cell is “barred” or the state of a cell is treated as “barred”, (1) when the state of the cell is treated as “barred” due to that the cell is unable to acquire the MIB and the cell is an NR-U cell, the terminal equipment may or will exclude the cell from the candidates of cell selection or cell reselection within at most 300 seconds, and/or, may or will consider a frequency of the cell to be the lowest priority within at most 300 seconds; and (2) otherwise, i.e. the MIB is obtained and when the state of the cell is treated as “barred” due to that the cell is unable to acquire the SIB1 and the cell is an NR-U cell, the terminal equipment may or will exclude the cell from the candidates of cell selection or cell reselection within at most 300 seconds, and/or, the terminal equipment may or will consider a frequency of the cell to be the lowest priority within at most 300 seconds. The above processing (1) and (2) may be executed separately, or may be executed together.

Example 7: when cell status “barred” is indicated or to be treated as when the cell status is “barred”, and when the at least two cells on a frequency are to be treated as when the cell status “barred” due to being unable to acquire the MIB and the at least two cells are NR-U cells, the terminal equipment considers the frequency of the at least two cells to be the lowest priority within the predefined first time; and/or, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, the terminal equipment considers the frequency of the at least two cells to be the lowest priority within the predefined first time.

For example, when it is indicated that a state of a cell is “barred” or the state of a cell is treated as “barred”, (1) when the states of at least two cells on a frequency are treated as “barred” due to that the cells are unable to acquire the MIB and the at least two cells are NR-U cells, the terminal equipment may or will consider the frequency of the at least two cells to be the lowest priority within at most 300 seconds; and (2) otherwise, i.e. the MIB is acquired and when the states of at least two cells on a frequency are treated as “barred” due to that the cells are unable to acquire the SIB1 and the at least two cells are NR-U cells, the terminal equipment may or will consider the frequency of the at least two cells to be the lowest priority within at most 300 seconds. The above processing (1) and (2) may be executed separately, or may be executed together.

Example 8: when the terminal equipment acquires the MIB but is unable to acquire the SIB1 on least one cell on an unlicensed frequency and intraFreqReselection in the MIB is set to not allow to perform barring, the terminal equipment considers the frequency of the at least one cell to be the lowest priority within the first time.

For a case where the number of cells on the at least one cell is 1, for example, when it is indicated that a state of a cell is “barred” or the state of a cell is treated as “barred”, and when the state of the cell is treated as “barred” due to that the cell is unable to acquire the SIB1 and the cell is an NR-U cell, and when intraFreqReselection in the acquired MIB is set to be “disallowed”, the terminal equipment may or will consider that the priority of the frequency of the cell is lowest within at most 300 seconds.

For a case where the number of cells on the at least one cell is multiple, i.e. at least 2, for example, when it is indicated that a state of a cell is “barred” or the state of a cell is treated as “barred”, and when the states of at least two cells are treated as “barred” due to that the cells are unable to acquire the SIB1 and the cells are NR-U cells, and when intraFreqReselection in the acquired MIB is set to be “disallowed”, the terminal equipment may or will consider that the priority of the frequency of the cells i is lowest within at most 300 seconds.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is the lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 2

The embodiment of this disclosure provides a method for configuring parameters for acquisition of essential system information, applicable to a network device side. This method corresponds to the method for processing when acquisition of essential system information fails in Embodiment 1, with identical contents being not going to be described herein any further. FIG. 4 is a schematic diagram of the method for configuring parameters for acquisition of essential system information of Embodiment 2 of this disclosure. As shown in FIG. 4, the method includes:

Step 401: a first number taken as the number of at least one cell is configured for a terminal equipment, or a second number used for determining the first number is configured for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

In this embodiment, the first number is an integer greater than or equal to 1, or, the first number is greater than or equal to the second number, and the second number is an integer greater than or equal to 1.

In this embodiment, a network device may configure a parameter, such as the first number or the second number, in a broadcast manner and/or by a dedicated signaling.

For example, when the broadcast manner is used in configuration, the parameter may be included in SIB2 as an intra-frequency or inter-frequency common parameter, or, the parameter may be as a frequency-specific parameter with intra-frequency included in SIB3 and inter-frequency included in SIB4.

For example, when the specialized manner is used in configuration, the parameter may be transferred via an RRCReconfiguration message, such as being included in IE UE-TimersAndConstants.

For example, when both the broadcast manner and specialized manner are supported, the parameter configured in the broadcast manner may be used before the parameter configured in the specialized manner is received. Once the parameter configured in the specialized manner is received, the parameter configured in the specialized manner is applied; when the terminal equipment leaves a connected state or gets into an idle state or an inactive state, the terminal equipment uses the specialized manner until, 1) another cell is reselected, or 2) a timer T3xx expires, wherein the T3xx may reuse T350 in LTE, or a new timer may be defined. When the T3xx is a new timer, the timer is started when the terminal equipment leaves the connected state or gets into the idle state or inactive state, and the timer is stopped when the terminal equipment gets into the connected state or performs cell reselection.

In this embodiment, as shown in FIG. 4, the method may further include:

Step 402: channel monitoring is performed by the network device on an unlicensed frequency.

In step 402, the network device performs the channel monitoring via, for example, LBT and/or CCA, and when it is monitored that the channel is busy, downlink transmission is not performed, that is, no system information is transmitted.

In this embodiment, there exists no timing relationship between step 401 and step 402, that is, a sequential order of the steps is not limited when step 401 and step 402 are executed.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 3

The embodiment of this disclosure provides a method for processing when acquisition of essential system information fails, applicable to a network device side and a terminal equipment side. This method corresponds to the method for processing when acquisition of essential system information fails in Embodiment 1, with identical contents being not going to be described herein any further.

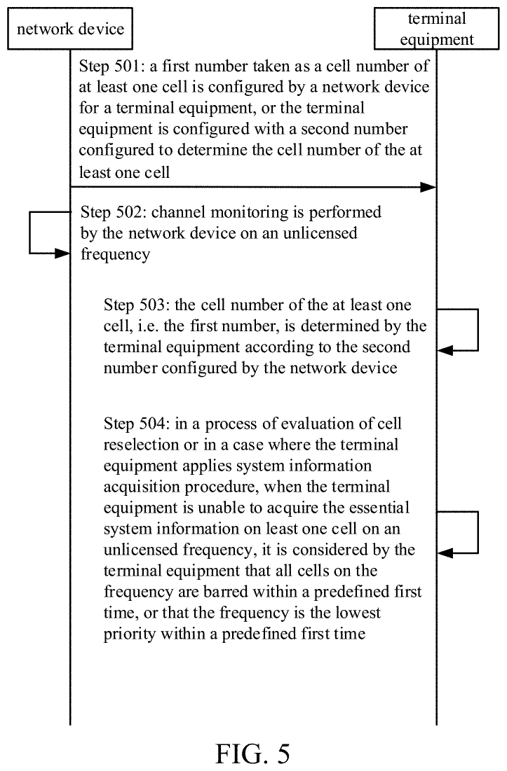

FIG. 5 is a schematic diagram of the method for processing when acquisition of essential system information fails of Embodiment 3 of this disclosure. As shown in FIG. 5, the method includes:

Step 501: a first number taken as a cell number of at least one cell is configured by a network device for a terminal equipment, or a second number configured to determine a cell number of at least one cell is configured by a network device for a terminal equipment;

Step 502: channel monitoring is performed by the network device on an unlicensed frequency;

Step 503: the cell number of the at least one cell, i.e. the first number, is determined by the terminal equipment according to the second number configured by the network device; and

Step 504: in a process of evaluation of cell reselection or in a case where the terminal equipment applies system information acquisition procedure, when the terminal equipment is unable to acquire the essential system information on least one cell on an unlicensed frequency, it is considered by the terminal equipment that all cells on the frequency are barred within a predefined first time, or that the frequency is the lowest priority within a predefined first time.

In step 502, the network device performs channel monitoring via, for example, LBT and/or CCA, and when it is monitored that the channel is busy, downlink transmission is not performed, that is, no system information is transmitted.

In this embodiment, there exists no timing relationship between steps 501-504, that is, a sequential order of the steps is not limited when steps 501-504 are executed.

In this embodiment, reference may be made to the description in Embodiment 1 and Embodiment 2 for the particular implementations of steps 501-504, which shall not be described herein any further.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 4

The embodiment of this disclosure provides an apparatus for processing when acquisition of essential system information fails, configured at a terminal equipment side. As a principle of the apparatus for solving problems is similar to that of the method of Embodiment 1, reference may be made to the implementations of the method of Embodiment 1 for implementations of this apparatus, with identical or related parts being not going to be described herein any further.

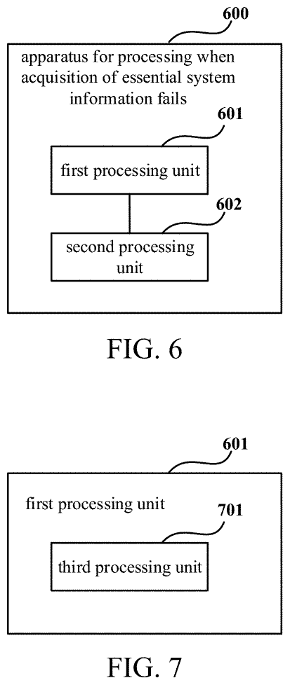

FIG. 6 is a schematic diagram of the apparatus for processing when acquisition of essential system information fails of Embodiment 4 of this disclosure. As shown in FIG. 6, an apparatus 600 includes:

a first processing unit 601 configured to, in a process of evaluation of cell reselection by a terminal equipment, or in a case where a terminal equipment applies system information acquisition procedure, when the terminal equipment is unable to acquire the essential system information on least one cell on an unlicensed frequency, consider that all cells on the frequency are barred within a predefined first time, or

a second processing unit 602 configured to, in a process of evaluation of cell reselection by a terminal equipment, or in a case where a terminal equipment applies system information acquisition procedure, when the terminal equipment is unable to acquire essential system information on least one cell on an unlicensed frequency, consider that the frequency is the lowest priority within a predefined first time.

FIG. 7 is a schematic diagram of the first processing unit of Embodiment 4 of this disclosure. As shown in FIG. 7, the first processing unit 601 includes:

a third processing unit 701 configured to, when the terminal equipment is unable to acquire at least one of MIB and SIB1 on the at least one cell on the unlicensed frequency, not consider that other cells on the same frequency as the at least one cell as candidates for cell selection or cell reselection within the first time.

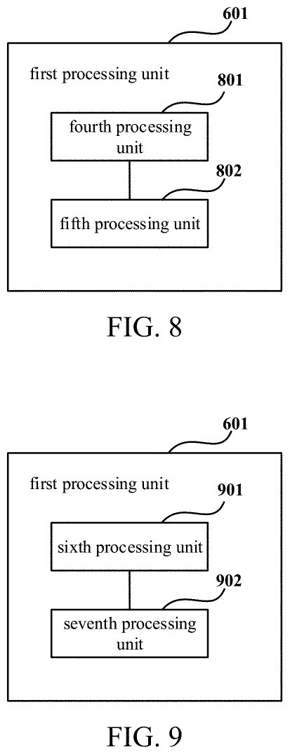

FIG. 8 is another schematic diagram of the first processing unit of Embodiment 4 of this disclosure. As shown in FIG. 8, the first processing unit 601 includes:

a fourth processing unit 801 configured to, when cell status “barred” is indicated or to be treated as when the cell status is “barred”, and when the cell is to be treated as when the cell status “barred” due to being unable to acquire the MIB and the cell is an NR-U cell, exclude the cell and/or other cells on the same frequency from the candidates of cell selection or cell reselection within the first time, and/or

a fifth processing unit 802 configured to, when cell status “barred” is indicated or to be treated as when the cell status is “barred”, when the terminal equipment acquires the MIB and when the cell is to be treated as when the cell status “barred” due to being unable to acquire the SIB1 and the cell is an NR-U cell, exclude the cell and/or other cells on the same frequency from the candidates of cell selection or cell reselection within the first time.

FIG. 9 is a further schematic diagram of the first processing unit of Embodiment 4 of this disclosure. As shown in FIG. 9, the first processing unit 601 includes:

a sixth processing unit 901 configured to, when cell status “barred” is indicated or to be treated as when the cell status is “barred”, and when the at least two cells on a frequency are to be treated as when the cell status “barred” due to being unable to acquire the MIB and the at least two cells are NR-U cells, exclude other cells on the same frequency as the at least two cells from the candidates of cell selection or cell reselection within the first time, and/or

a seventh processing unit 902 configured to, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, exclude other cells on the same frequency as the at least two cells from the candidates of cell selection or cell reselection within the first time.

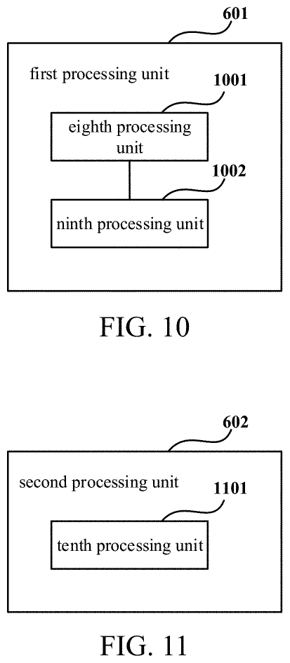

FIG. 10 is still another schematic diagram of the first processing unit of Embodiment 4 of this disclosure. As shown in FIG. 10, the first processing unit 601 includes:

an eighth processing unit 1001 configured to, when the terminal equipment is in an idle state, or in an inactive state, or in a connected state while a timer T311 is running, when the terminal equipment is unable to acquire the MIB on least one cell on an unlicensed frequency, consider the at least one cell as barred and perform barring as when intraFreqReselection in the MIB is set to not allowed, and/or

a ninth processing unit 1002 configured to, when the terminal equipment is in an idle state or in an inactive state or in a connected state while a timer T311 is running, when the terminal equipment acquires the MIB and is unable to acquire the SIB1 on least one cell on an unlicensed frequency, consider the at least one cell as barred and perform barring as when intraFreqReselection in the MIB is set to not allowed.

FIG. 11 is a schematic diagram of the second processing unit of Embodiment 4 of this disclosure. As shown in FIG. 11, the second processing unit 602 includes:

a tenth processing unit 1101 configured to, when the terminal equipment is unable to acquire at least one of the MIB and the SIB1 on least one cell on an unlicensed frequency, consider the frequency of the at least one cell to be the lowest priority within the first time.

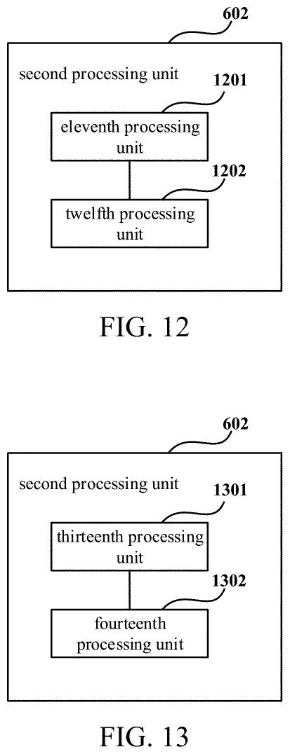

FIG. 12 is another schematic diagram of the second processing unit of Embodiment 4 of this disclosure. As shown in FIG. 12, the second processing unit 602 includes:

an eleventh processing unit 1201 configured to, when cell status “barred” is indicated or to be treated as when the cell status is “barred”, and when the cell is to be treated as when the cell status “barred” due to being unable to acquire the MIB and the cell is an NR-U cell, exclude the cell from the candidates of cell selection or cell reselection within the first time, or consider a frequency of the cell to be the lowest priority within the first time, and/or

a twelfth processing unit 1202 configured to, when cell status “barred” is indicated or to be treated as when the cell status is “barred”, and when the terminal equipment acquires the MIB and the cell is to be treated as when the cell status “barred” due to being unable to acquire the SIB1 and the cell is an NR-U cell, exclude the cell from the candidates of cell selection or cell reselection within the first time, or consider a frequency of the cell to be the lowest priority within the first time.

FIG. 13 is a further schematic diagram of the second processing unit of Embodiment 4 of this disclosure. As shown in FIG. 13, the second processing unit 602 includes:

a thirteenth processing unit 1301 configured to, when cell status “barred” is indicated or to be treated as when the cell status is “barred”, and when the at least two cells on a frequency are to be treated as when the cell status “barred” due to being unable to acquire the MIB and the at least two cells are NR-U cells, consider the frequency of the at least two cells to be the lowest priority within the predefined first time, and/or

a fourteenth processing unit 1302 configured to, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, consider the frequency of the at least two cells to be the lowest priority within the predefined first time.

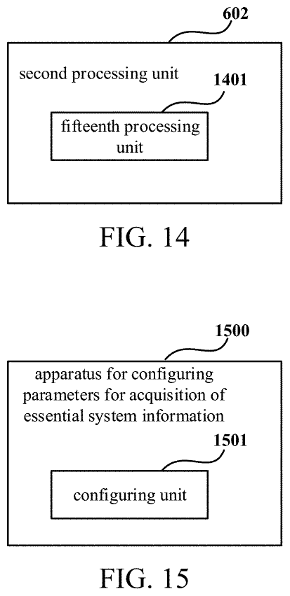

FIG. 14 is still another schematic diagram of the second processing unit of Embodiment 4 of this disclosure. As shown in FIG. 14, the second processing unit 602 includes:

a fifteenth processing unit 1401 configured to, when the terminal equipment acquires the MIB and is unable to acquire the SD31 on least one cell on an unlicensed frequency and intraFreqReselection in the MIB is set to not allow to perform barring, consider the frequency of the at least one cell to be the lowest priority within the first time.

In this embodiment, reference may be made to the contents of the steps in Embodiment 1 for implementations of functions of the above units, which shall not be described herein any further.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 5

The embodiment of this disclosure provides an apparatus for configuring parameters for acquisition of essential system information, configured at a network device side. As a principle of the apparatus for solving problems is similar to that of the method of Embodiment 2, reference may be made to the implementations of the method of Embodiment 2 for implementations of this apparatus, with identical or related parts being not going to be described herein any further.

FIG. 15 is a schematic diagram of the apparatus for configuring parameters for acquisition of essential system information of Embodiment 5 of this disclosure. As shown in FIG. 15, an apparatus 1500 includes:

a configuring unit 1501 configured to configure a first number taken as the number of at least one cell for a terminal equipment, or configure a second number used for determining the first number for the terminal equipment, so that in a process of performing evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

In this embodiment, the first number may be greater than or equal to the second number, and the second number is an integer greater than or equal to 1.

In this embodiment, the configuring unit 1501 configures the first number or the second number in a broadcast manner and/or by a dedicated signaling.

In this embodiment, reference may be made to the contents of the steps in Embodiment 2 for implementations of functions of the above units, which shall not be described herein any further.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 6

The embodiment of this disclosure provides a terminal equipment, including the apparatus for processing when acquisition of essential system information fails as described in Embodiment 4.

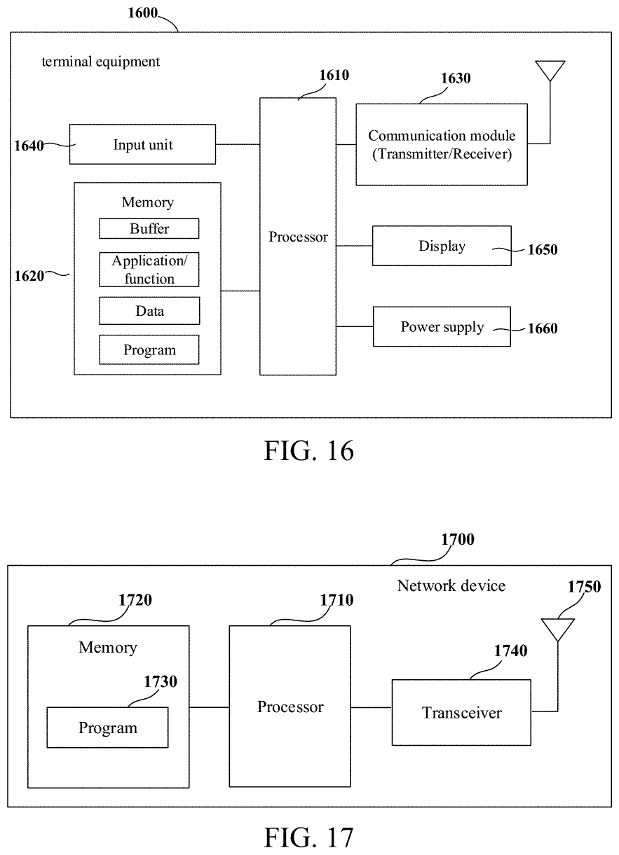

FIG. 16 is a block diagram of a structure of the terminal equipment of Embodiment 6 of this disclosure. As shown in FIG. 16, a terminal equipment 1600 may include a processor 1610 and a memory 1620, the memory 1620 being coupled to the processor 1610. It should be noted that this figure is illustrative only, and other types of structures may also be used, so as to supplement or replace this structure and achieve a telecommunications function or other functions. In one implementation, the functions of the apparatus for processing when acquisition of essential system information fails may be integrated into the processor 1610. In this embodiment, the processor 1610 may be configured to: in a process of evaluation of cell reselection by a terminal equipment, or in a case where a terminal equipment applies system information acquisition procedure, when the terminal equipment is unable to acquire the essential system information on least one cell on an unlicensed frequency, consider that all cells on the frequency are barred within a predefined first time, or, consider that the frequency is the lowest priority within a predefined first time.

In another implementation, the apparatus for processing when acquisition of essential system information fails and the processor 1610 may be configured separately; for example, the apparatus for processing when acquisition of essential system information fails may be configured as a chip connected to the processor 1610, and the functions of the apparatus for processing when acquisition of essential system information fails are executed under control of the processor 1610.

As shown in FIG. 16, the terminal equipment 1600 may further include a communication module 1630, an input unit 1640, a display 1650 and a power supply 1660. It should be noted that the terminal equipment 1600 does not necessarily include all the parts shown in FIG. 16. Furthermore, the terminal equipment 1600 may include parts not shown in FIG. 16, and the prior art may be referred to.

As shown in FIG. 16, the processor 1610 is sometimes referred to as a controller or an operational control, which may include a microprocessor or other processor devices and/or logic devices. The processor 1610 receives input and controls operations of components of the terminal equipment 1600.

In this embodiment, the memory 1620 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1610 may execute programs stored in the memory 1620, so as to realize information storage or processing, etc. Functions of other parts are similar to those of the prior art, which shall not be described herein any further. The parts of the terminal equipment 1600 may be realized by specific hardware, firmware, software, or any combination thereof, without departing from the scope of this disclosure.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 7

The embodiment of this disclosure provides a network device, including the apparatus for configuring parameters for acquisition of essential system information described in Embodiment 5.

FIG. 17 is a schematic diagram of a structure of the network device of Embodiment 7 of this disclosure. As shown in FIG. 17, a network device 1700 may include a processor 1710 and a memory 1720, the memory 1720 being coupled to the processor 1710. The memory 1720 may store various data, and furthermore, it may store a program 1730 for data processing, and execute the program 1730 under control of the processor 1710, so as to receive various information transmitted by a terminal equipment, and transmit various information to the terminal equipment.

In one implementation, the functions of the apparatus for configuring parameters for acquisition of essential system information may be integrated into the processor 1710. In this embodiment, the processor 1710 may be configured to: configure a first number taken as the number of at least one cell for a terminal equipment, or configure a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

In another implementation, the apparatus for configuring parameters for acquisition of essential system information and the processor 1710 may be configured separately; for example, the apparatus for configuring parameters for acquisition of essential system information may be configured as a chip connected to the processor 1710, and the functions of the apparatus for configuring parameters for acquisition of essential system information are executed under control of the processor 1710.

Furthermore, as shown in FIG. 17, the network device 1700 may include a transceiver 1740, and an antenna 1750, etc. Functions of the above components are similar to those in the prior art, and shall not be described herein any further. It should be noted that the network device 1700 does not necessarily include all the parts shown in FIG. 17. Furthermore, the network device 1700 may include parts not shown in FIG. 17, and the prior art may be referred to.

It can be seen from the above embodiment that in a process of evaluation of cell reselection by a terminal equipment, or in a case where a terminal equipment applies system information acquisition procedure, when the terminal equipment is unable to acquire the essential system information on least one cell on an unlicensed frequency, the terminal equipment considers that all cells on the frequency are barred within a predefined first time, or, the terminal equipment considers that the frequency is a frequency of a lowest priority within a predefined first time. Hence, the terminal equipment may be prevented from always making attempt to acquire essential system information on the same unlicensed frequency, thus enabling the terminal equipment to save power and find a suitable cell to camp on as soon as possible.

### Embodiment 8

The embodiment of this disclosure provides a communication system, including the terminal equipment described in Embodiment 6 and/or the network device described in Embodiment 7.

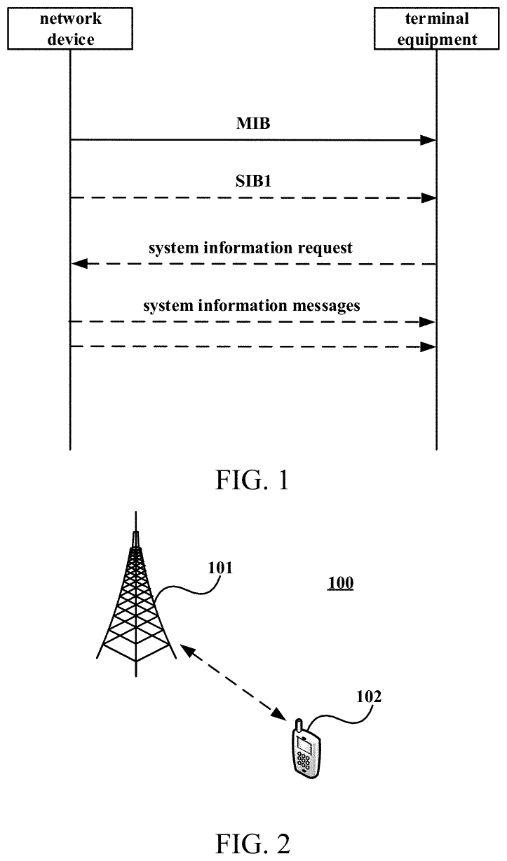

For example, reference may be made to FIG. 1 for a structure of the communication system. As shown in FIG. 1, the communication system 100 includes a network device 101 and a terminal equipment 102. The terminal equipment 102 is identical to the terminal equipment described in Embodiment 6, and the network device 101 is identical to the network device in Embodiment 7, with identical contents being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 6 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, when equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 6 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 6 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

According to the above implementations disclosed in the embodiments, following supplements are further disclosed.

1. An apparatus for processing when acquisition of essential system information fails, applicable to a terminal equipment side, the apparatus including:

a first processing unit configured to, in a process of evaluation of cell reselection by a terminal equipment, or in a case where a terminal equipment applies system information acquisition procedure, when the terminal equipment is unable to acquire the essential system information on least one cell on an unlicensed frequency, consider that all cells on the frequency are barred within a predefined first time, or

a second processing unit configured to, in a process of evaluation of cell reselection by a terminal equipment, or in a case where a terminal equipment applies system information acquisition procedure, when the terminal equipment is unable to acquire essential system information on least one cell on an unlicensed frequency, consider that the frequency is the lowest priority within a predefined first time.

2. The apparatus according to supplement 1, wherein,

the number of the at least one cell is a first number, the first number being configured by a network device, or predefined, or determined by the terminal equipment.

3. The apparatus according to supplement 1, wherein,

the number of the at least one cell is a first number, the first number being greater than or equal to a second number, the second number being an integer greater than or equal to 1.

4. The apparatus according to supplement 3, wherein,

the second number is configured by the network device, or predefined, or determined by the terminal equipment.

5. The apparatus according to any one of supplements 1-4, wherein,

the first time is less than or equal to a first threshold.

6. The apparatus according to any one of supplements 1-5, wherein,

the essential system information includes at least one of an MIB and SIB1.

7. The apparatus according to supplement 6, wherein,

for the MIB and the SIB1 as the essential system information, the numbers of the at least one cell are identical or different, and/or, identical or different processing units in the first processing unit and the second processing unit are used for processing.

8. The apparatus according to any one of supplements 1-7, wherein,

the first processing unit includes:

a third processing unit configured to, when the terminal equipment is unable to acquire at least one of the MIB and the SIB1 on the at least one cell on the unlicensed frequency, not consider that other cells on the same frequency as the at least one cell as candidates for cell selection or cell reselection within the first time.

9. The apparatus according to any one of supplements 1-7, wherein,

the first processing unit includes:

a fourth processing unit configured to, when cell status “barred” is indicated or to be treated as when the cell status is “barred”, and when the cell is to be treated as when the cell status “barred” due to being unable to acquire the MIB and the cell is an NR-U cell, exclude the cell and/or other cells on the same frequency as a candidate for cell selection or cell reselection within the first time, and/or

a fifth processing unit configured to, when cell status “barred” is indicated or to be treated as when the cell status is “barred”, when the terminal equipment acquires the MIB and when the cell is to be treated as when the cell status “barred” due to being unable to acquire the SIB1 and the cell is an NR-U cell, exclude the cell and/or other cells on the same frequency as a candidate for cell selection or cell reselection within the first time.

10. The apparatus according to any one of supplements 1-7, wherein,

the first processing unit includes:

a sixth processing unit configured to, when cell status “barred” is indicated or to be treated as when the cell status is “barred”, and when the at least two cells on a frequency are to be treated as when the cell status “barred” due to being unable to acquire the MIB and the at least two cells are NR-U cells, exclude other cells on the same frequency as the at least two cells as candidates for cell selection or cell reselection within the first time, and/or

a seventh processing unit configured to, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, exclude other cells on the same frequency as the at least two cells as candidates for cell selection or cell reselection within the first time.

11. The apparatus according to any one of supplements 1-7, wherein,

the first processing unit includes:

an eighth processing unit configured to, when the terminal equipment is in an idle state, or in an inactive state, or in a connected state while a timer T311 is running, when the terminal equipment is unable to acquire the MIB on least one cell on an unlicensed frequency, consider the at least one cell as barred and perform barring as when intraFreqReselection in the MIB is set to not allowed, and/or

a ninth processing unit configured to, when the terminal equipment is in an idle state or in an inactive state or in a connected state while a timer T311 is running, when the terminal equipment acquires the MIB and is unable to acquire the SIB1 on least one cell on an unlicensed frequency, consider the at least one cell as barred and perform barring as when intraFreqReselection in the MIB is set to not allowed.

12. The apparatus according to any one of supplements 1-7, wherein,

the second processing unit includes:

a tenth processing unit configured to, when the terminal equipment is unable to acquire at least one of the MIB and the SIB1 on least one cell on an unlicensed frequency, consider the frequency of the at least one cell to be the lowest priority within the first time.

13. The apparatus according to any one of supplements 1-7, wherein,

the second processing unit includes:

an eleventh processing unit configured to, when cell status “barred” is indicated or to be treated as when the cell status is “barred”, and when the cell is to be treated as when the cell status “barred” due to being unable to acquire the MIB and the cell is an NR-U cell, exclude the cell as a candidate for cell selection or cell reselection within the first time, or consider a frequency of the cell to be the lowest priority within the first time, and/or

a twelfth processing unit configured to, when cell status “barred” is indicated or to be treated as when the cell status is “barred”, and when the terminal equipment acquires the MIB and the cell is to be treated as when the cell status “barred” due to being unable to acquire the SIB1 and the cell is an NR-U cell, exclude the cell as a candidate for cell selection or cell reselection within the first time, or consider a frequency of the cell to be the lowest priority within the first time.

14. The apparatus according to any one of supplements 1-7, wherein,

the second processing unit includes:

a thirteenth processing unit configured to, when cell status “barred” is indicated or to be treated as when the cell status is “barred”, and when the at least two cells on a frequency are to be treated as when the cell status “barred” due to being unable to acquire the MIB and the at least two cells are NR-U cells, consider the frequency of the at least two cells to be the lowest priority within the first time, and/or

a fourteenth processing unit configured to, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, consider the frequency of the at least two cells to be the lowest priority within the first time.

15. The apparatus according to any one of supplements 1-7, wherein,

the second processing unit includes:

a fifteenth processing unit configured to, when the terminal equipment acquires the MIB and is unable to acquire the SIB1 on least one cell on an unlicensed frequency and intraFreqReselection in the MIB is set to not allow to perform barring, consider the frequency of the at least one cell to be the lowest priority within the first time.

16. An apparatus for configuring parameters for acquisition of essential system information, applicable to a network device side, the apparatus including:

a configuring unit configured to configure a first number taken as the number of at least one cell for a terminal equipment, or configure a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

17. The apparatus according to supplement 16, wherein, the first number is greater than or equal to the second number, and the second number is an integer greater than or equal to 1.

18. The apparatus according to supplement 16 or 17, wherein, the configuring unit configures the first number or the second number in a broadcast manner and/or by a dedicated signaling.

19. A terminal equipment, including the apparatus according to any one of supplements 1-15.

20. A network device, including the apparatus according to any one of supplements 16-18.

21. A communication system, including the terminal equipment according to supplement 19 and/or the network device according to supplement 20.

22. A method for processing when acquisition of essential system information fails, applicable to a terminal equipment side, the method including:

in a process of evaluation of cell reselection by a terminal equipment, or in a case where a terminal equipment applies system information acquisition procedure,

when the terminal equipment is unable to acquire the essential system information on least one cell on an unlicensed frequency, considering that all cells on the frequency are barred within a predefined first time, or, considering that the frequency is the lowest priority within a predefined first time.

23. The method according to supplement 22, wherein,

the number of the at least one cell is a first number, the first number being configured by a network device, or predefined, or determined by the terminal equipment.

24. The method according to supplement 22, wherein,

the number of the at least one cell is a first number, the first number being greater than or equal to a second number, the second number being an integer greater than or equal to 1.

25. The method according to supplement 24, wherein,

the second number is configured by the network device, or predefined, or determined by the terminal equipment.

26. The method according to any one of supplements 22-25, wherein,

the first time is less than or equal to a first threshold.

27. The method according to any one of supplements 22-26, wherein,

the essential system information includes at least one of an MIB and SIB1.

28. The method according to supplement 27, wherein,

for the MIB and the S1131 as the essential system information, the numbers of the at least one cell are identical or different, and/or, identical or different processing units in the first processing unit and the second processing unit are used for processing.

29. The method according to any one of supplements 22-28, wherein,

that when the terminal equipment is unable to acquire the essential system information on the at least one cell on the unlicensed frequency, considering by the terminal equipment that all cells on the frequency are barred within the first time, includes:

when the terminal equipment is unable to acquire at least one of the MIB and the SIB1 on the at least one cell on the unlicensed frequency, considering by the terminal equipment that other cells on the same frequency as the at least one cell are not candidates of cell selection or cell reselection within the first time.

30. The method according to any one of supplements 22-28, wherein,

that when the terminal equipment is unable to acquire the essential system information on the at least one cell on the unlicensed frequency, considering by the terminal equipment that all cells on the frequency are barred within the first time, includes:

when cell status “barred” is indicated or to be treated as when the cell status is “barred”, and when the cell is to be treated as when the cell status “barred” due to being unable to acquire the MIB and the cell is an NR-U cell, excluding the cell and/or other cells on the same frequency as a candidate for cell selection or cell reselection within the first time by the terminal equipment, and/or

when cell status “barred” is indicated or to be treated as when the cell status is “barred”, when the terminal equipment acquires the MIB and when the cell is to be treated as when the cell status “barred” due to being unable to acquire the SIB1 and the cell is an NR-U cell, excluding the cell and/or other cells on the same frequency as a candidate for cell selection or cell reselection within the first time by the terminal equipment.

31. The method according to any one of supplements 22-28, wherein,

that when the terminal equipment is unable to acquire the essential system information on the at least one cell on the unlicensed frequency, considering by the terminal equipment that all cells on the frequency are barred within the first time, includes:

when cell status “barred” is indicated or to be treated as when the cell status is “barred”, and when the at least two cells on a frequency are to be treated as when the cell status “barred” due to being unable to acquire the MIB and the at least two cells are NR-U cells, excluding other cells on the same frequency as the at least two cells as candidates for cell selection or cell reselection within the first time by the terminal equipment, and/or

when cell status “barred” is indicated or to be treated as when the cell status is “barred”, and when the MIB is acquired and the at least two cells on a frequency are to be treated as when the cell status “barred” due to being unable to acquire the SD31 and the at least two cells are NR-U cells, exclude other cells on the same frequency as the at least two cells as candidates for cell selection or cell reselection within the first time by the terminal equipment.

32. The method according to any one of supplements 22-28, wherein,

that when the terminal equipment is unable to acquire the essential system information on the at least one cell on the unlicensed frequency, considering by the terminal equipment that all cells on the frequency are barred within the first time, includes:

when the terminal equipment is in an idle state, or in an inactive state, or in a connected state while a timer T311 is running, when the terminal equipment is unable to acquire the MIB on least one cell on an unlicensed frequency, considering that the at least one cell is barred and taking intraFreqReselection in the MIB as being set to not allow to perform barring by the terminal equipment, and/or

when the terminal equipment is in an idle state or in an inactive state or in a connected state while a timer T311 is running, when the terminal equipment acquires the MIB and is unable to acquire the SIB1 on least one cell on an unlicensed frequency, considering that the at least one cell is barred and taking intraFreqReselection in the MIB as being set to not allow to perform barring by the terminal equipment.

33. The method according to any one of supplements 22-28, wherein,

that when the terminal equipment is unable to acquire the essential system information on least one cell on an unlicensed frequency, considering that all cells on the frequency are barred within a predefined first time, or, considering that the frequency is a frequency of a lowest priority within a predefined first time, includes:

when the terminal equipment is unable to acquire at least one of the MIB and the SIB1 on least one cell on an unlicensed frequency, considering by the terminal equipment the frequency of the at least one cell to be the lowest priority within the first time.

34. The method according to any one of supplements 22-28, wherein,

that when the terminal equipment is unable to acquire the essential system information on least one cell on an unlicensed frequency, considering by the terminal equipment that the frequency is a frequency of a lowest priority within a predefined first time, includes:

when cell status “barred” is indicated or to be treated as when the cell status is “barred”, and when the cell is to be treated as when the cell status “barred” due to being unable to acquire the MIB and the cell is an NR-U cell, excluding the cell as a candidate for cell selection or cell reselection within the first time by the terminal equipment, or considering a frequency of the cell to be the lowest priority within the first time by the terminal equipment, and/or

when cell status “barred” is indicated or to be treated as when the cell status is “barred”, and when the terminal equipment acquires the MIB and the cell is to be treated as when the cell status “barred” due to being unable to acquire the SIB1 and the cell is an NR-U cell, excluding the cell as a candidate for cell selection or cell reselection within the first time by the terminal equipment, or considering a frequency of the cell to be the lowest priority within the first time by the terminal equipment.

35. The method according to any one of supplements 22-28, wherein,

that when the terminal equipment is unable to acquire the essential system information on least one cell on an unlicensed frequency, considering by the terminal equipment that the frequency is a frequency of a lowest priority within a predefined first time, includes:

when cell status “barred” is indicated or to be treated as when the cell status is “barred”, and when the at least two cells on a frequency are to be treated as when the cell status “barred” due to being unable to acquire the MIB and the at least two cells are NR-U cells, considering by the terminal equipment the frequency of the at least two cells to be the lowest priority within the predefined first time, and/or

when cell status “barred” is indicated or to be treated as when the cell status is “barred”, and when the MIB is acquired and the at least two cells on a frequency are to be treated as when the cell status “barred” due to being unable to acquire the SD31 and the at least two cells are NR-U cells, considering by the terminal equipment the frequency of the at least two cells to be the lowest priority within the predefined first time.

36. The method according to any one of supplements 22-28, wherein,

that when the terminal equipment is unable to acquire the essential system information on least one cell on an unlicensed frequency, considering by the terminal equipment that the frequency is a frequency of a lowest priority within a predefined first time, includes:

when the terminal equipment acquires the MIB and is unable to acquire the SIB1 on least one cell on an unlicensed frequency and intraFreqReselection in the MIB is set to not allow to perform barring, considering by the terminal equipment the frequency of the at least one cell to be the lowest priority within the first time.

37. A method for configuring parameters for acquisition of essential system information, applicable to a network device side, the method including:

configuring a first number taken as the number of at least one cell for a terminal equipment, or configuring a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

38. The method according to supplement 37, wherein,

the first number is greater than or equal to the second number, and the second number is an integer greater than or equal to 1.

39. The method according to supplement 37 or 38, wherein,

the first number or the second number is configured in a broadcast manner and/or by a dedicated signaling.

What is claimed is:

1. An apparatus for processing when acquisition of essential system information fails, applicable to a terminal equipment side, the apparatus comprising:
a first processing unit configured to, in a process of evaluation of cell reselection by a terminal equipment, or in a case where a terminal equipment applies system information acquisition procedure, when the terminal equipment is unable to acquire the essential system information on least one cell on an unlicensed frequency, consider that all cells on the frequency are barred within a predefined first time, or
a second processing unit configured to, in a process of evaluation of cell reselection by a terminal equipment, or in a case where a terminal equipment applies system information acquisition procedure, when the terminal equipment is unable to acquire essential system information on least one cell on an unlicensed frequency, consider that the frequency is the lowest priority within a predefined first time.

2. The apparatus according to claim 1, wherein,
the number of the at least one cell is a first number, the first number being configured by a network device, or predefined, or determined by the terminal equipment.

3. The apparatus according to claim 1, wherein,
the number of the at least one cell is a first number, the first number being greater than or equal to a second number, the second number being an integer greater than or equal to 1.

4. The apparatus according to claim 3, wherein,
the second number is configured by the network device, or predefined, or determined by the terminal equipment.

5. The apparatus according to claim 1, wherein,
the first time is less than or equal to a first threshold.

6. The apparatus according to claim 1, wherein,
the essential system information comprises at least one of an MIB and SIB1.

7. The apparatus according to claim 6, wherein,
for the MIB and the SIB1 as the essential system information, the numbers of the at least one cell are identical or different, and/or, identical or different processing units in the first processing unit and the second processing unit are used for processing.

8. The apparatus according to claim 1, wherein,
the first processing unit comprises:
a third processing unit configured to, when the terminal equipment is unable to acquire at least one of the MIB and the SIB1 on the at least one cell on the unlicensed frequency, not consider that other cells on the same frequency as the at least one cell as candidates for cell selection or cell reselection within the first time.

9. The apparatus according to claim 1, wherein,
the first processing unit comprises:
a fourth processing unit configured to, when cell status “barred” is indicated or to be treated as when the cell status is “barred”, and when the cell is to be treated as when the cell status “barred” due to being unable to acquire the MIB and the cell is an NR-U cell, exclude the cell and/or other cells on the same frequency as a candidate for cell selection or cell reselection within the first time, and/or
a fifth processing unit configured to, when cell status “barred” is indicated or to be treated as when the cell status is “barred”, when the terminal equipment acquires the MIB and when the cell is to be treated as when the cell status “barred” due to being unable to acquire the SIB1 and the cell is an NR-U cell, exclude the cell and/or other cells on the same frequency as a candidate for cell selection or cell reselection within the first time.

10. The apparatus according to claim 1, wherein,
the first processing unit comprises:
a sixth processing unit configured to, when cell status “barred” is indicated or to be treated as when the cell status is“barred”, and when the at least two cells on a frequency are to be treated as when the cell status“barred”due to being unable to acquire the MIB and the at least two cells are NR-U cells, exclude other cells on the same frequency as the at least two cells as candidates for cell selection or cell reselection within the first time, and/or
a seventh processing unit configured to, when cell status “barred” is indicated or to be treated as when the cell status is “barred”, and when the MIB is acquired and the at least two cells on a frequency are to be treated as when the cell status“barred”due to being unable to acquire the SIB1 and the at least two cells are NR-U cells, exclude other cells on the same frequency as the at least two cells as candidates for cell selection or cell reselection within the first time.

11. The apparatus according to claim 1, wherein,
the first processing unit comprises:
an eighth processing unit configured to, when the terminal equipment is in an idle state, or in an inactive state, or in a connected state while a timer T311 is running, when the terminal equipment is unable to acquire the MIB on least one cell on an unlicensed frequency, consider the at least one cell as barred and perform barring as when intraFreqReselection in the MIB is set to not allowed, and/or
a ninth processing unit configured to, when the terminal equipment is in an idle state or in an inactive state or in a connected state while a timer T311 is running, when the terminal equipment acquires the MIB and is unable to acquire the SIB1 on least one cell on an unlicensed frequency, consider the at least one cell as barred and perform barring as when intraFreqReselection in the MIB is set to not allowed.

12. The apparatus according to claim 1, wherein,
the second processing unit comprises:
a tenth processing unit configured to, when the terminal equipment is unable to acquire at least one of the MIB and the SIB1 on least one cell on an unlicensed frequency, consider the frequency of the at least one cell to be the lowest priority within the first time.

13. The apparatus according to claim 1, wherein,
the second processing unit comprises:
an eleventh processing unit configured to, when cell status “barred” is indicated or to be treated as when the cell status is “barred”, and when the cell is to be treated as when the cell status “barred” due to being unable to acquire the MIB and the cell is an NR-U cell, exclude the cell as a candidate for cell selection or cell reselection within the first time, or consider a frequency of the cell to be the lowest priority within the first time, and/or
a twelfth processing unit configured to, when cell status “barred” is indicated or to be treated as when the cell status is “barred”, and when the terminal equipment acquires the MIB and the cell is to be treated as when the cell status “barred” due to being unable to acquire the SIB1 and the cell is an NR-U cell, exclude the cell as a candidate for cell selection or cell reselection within the first time, or consider a frequency of the cell to be the lowest priority within the first time.

14. The apparatus according to claim 1, wherein,
the second processing unit comprises:
a thirteenth processing unit configured to, when cell status “barred” is indicated or to be treated as when the cell status is “barred”, and when the at least two cells on a frequency are to be treated as when the cell status “barred” due to being unable to acquire the MIB and the at least two cells are NR-U cells, consider the frequency of the at least two cells to be the lowest priority within the predefined first time, and/or
a fourteenth processing unit configured to, when cell status “barred” is indicated or to be treated as when the cell status is “barred”, and when the MIB is acquired and the at least two cells on a frequency are to be treated as when the cell status “barred” due to being unable to acquire the SIB1 and the at least two cells are NR-U cells, consider the frequency of the at least two cells to be the lowest priority within the predefined first time.

15. The apparatus according to claim 1, wherein,
the second processing unit comprises:
a fifteenth processing unit configured to, when the terminal equipment acquires the MIB and is unable to acquire the SIB1 on least one cell on an unlicensed frequency and intraFreqReselection in the MIB is set to not allow to perform barring, consider the frequency of the at least one cell to be the lowest priority within the first time.

16. An apparatus for configuring parameters for acquisition of essential system information, applicable to a network device side, the apparatus comprising:
processor circuitry to configure a first number taken as the number of at least one cell for a terminal equipment, or configure a second number used for determining the first number for the terminal equipment, so that in a process of evaluation of cell reselection or in a case where the terminal equipment applies system information acquisition procedure, when the terminal equipment is unable to acquire the essential system information on least one cell on an unlicensed frequency, the terminal equipment considers that all cells on the frequency are barred within a predefined first time, or that the frequency is the lowest priority within a predefined first time.

17. The apparatus according to claim 16, wherein,
the first number is greater than or equal to the second number, and the second number is an integer greater than or equal to 1.

18. The apparatus according to claim 16, wherein,
the processor circuitry configures the first number or the second number in a broadcast manner and/or by a dedicated signaling.

19. A terminal equipment, comprising:
a processing circuitry configured to, in a process of evaluation of cell reselection by the terminal equipment, or in a case where the terminal equipment applies system information acquisition procedure, when the terminal equipment is unable to acquire the essential system information on least one cell on an unlicensed frequency, consider that all cells on the frequency are barred within a predefined first time, or
configured to, in a process of evaluation of cell reselection by the terminal equipment, or in a case where the terminal equipment applies system information acquisition procedure, when the terminal equipment is unable to acquire essential system information on least one cell on an unlicensed frequency, consider that the frequency is the lowest priority within a predefined first time.
